(19) United States
(12) Patent Application Publication
(10) Pub. No.: US 2014/0025588 A1
(43) Pub. Date: Jan. 23, 2014

(54) METHODS AND SYSTEMS FOR AUTOMATED ISSUE RESOLUTION

(71) Applicant: Shanmugam Chinnappa, Sterling, VA (US)

(72) Inventor: Shanmugam Chinnappa, Sterling, VA (US)

(73) Assignee: Amdocs Software Systems Limited.

(21) Appl. No.: 13/554,357

(22) Filed: Jul. 20, 2012

(51) Int. Cl. G06Q 10/00

(52) U.S. Cl. 705/304

(57) ABSTRACT

Methods and systems for resolving problems are disclosed. The methods and systems receive a communication regarding a first symptom of an underlying problem. In addition, the methods and systems perform operations to resolve the problem. If the problem is resolved, the methods and systems identify the problem by comparing the performed operations to a model. The methods and systems wait for a first amount of time and, after waiting for the first amount of time, determine whether a second symptom indicative of the problem is present. In some embodiments, if the problem is present the methods and systems attempt to resolve the problem. In addition, in some embodiments, if the problem is not present, the methods and systems mark the problem as resolved.

### TECHNICAL FIELD

The present disclosure relates to the field of issue resolution and, more particularly, methods and systems for detecting symptoms indicative of one or more underlying problems and resolving one or more problems based, for example, on past problem resolution.

### BACKGROUND

Companies commonly employ customer service representatives (CSRs) to speak with, and resolve issues or problems for, customers. Customer Relationship Management (CRM) software has been developed that assists CSRs when attempting to resolve issues for customers. For example, CRM software may allow CSRs to record notes regarding a call with a customer. In addition, CRM software may allow CSRs to record a reason code indicating a suspected problem underlying a customer's call. However, CRM software is typically heavily dependent upon a representative's individual ability to determine a problem underlying a customer's call. Thus, an inexperienced CSR may not be able to efficiently resolve a customer's problem. Similarly, an experienced CSR may not be able to efficiently resolve a customer's problem when the problem is uncommon or complex.

In addition, traditional CRM software does not determine whether a customer's problem is permanently resolved. In particular, while a problem may be temporarily fixed when a CSR is on the phone with a customer, the problem may reoccur. Companies have traditionally relied on surveys and follow-up calls to determine whether a problem has reoccurred. However, surveys and follow-up calls can be subjective and expensive.

To avoid the subjectivity and expense of surveys and follow-up calls, companies often forgo proactive monitoring of issue resolution. Rather, some companies may wait for customers to call back about a problem that has reoccurred. However, requiring active customer involvement can be frustrating and time consuming for customers.

### SUMMARY

In one disclosed embodiment, a method for resolving problems is disclosed. The method comprises receiving a communication regarding a first symptom of an underlying problem. In addition, the method comprises performing operations to resolve the problem and, if the problem is resolved, identifying the problem, using a processor, by comparing the performed operations to a model. In addition, the method comprises waiting for a first amount of time, and, after waiting for the first amount of time, determining whether a second symptom indicative of the problem is present.

In another disclosed embodiment, a system for resolving problems is disclosed. The system comprises a processor, a memory, and program stored in the memory. The program code, when executed by the processor, causes the system to receive a communication regarding a first symptom of an underlying problem, perform operations to resolve the problem, and, if the problem is resolved, identify the problem, using the processor, by comparing the performed operations to a model, wait for a first amount of time, and determine whether a second symptom indicative of the problem is present after waiting for the first amount of time.

Additional aspects related to the embodiments will be set forth in part in the description which follows, and in part will be obvious from the description, or may be learned by practice of the invention.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an example system that may be used for implementing the disclosed embodiments.

FIG. 2 illustrates an example system that may be used for implementing the disclosed embodiments.

FIG. 3 illustrates an example method for resolving and following up on a problem.

FIG. 4 illustrates an example method for determining that a problem has been resolved.

FIG. 5 illustrates an example method for resolving and following up on a problem.

FIG. 6 illustrates an example model for mapping steps taken to resolve a problem to the identity of the problem.

### DETAILED DESCRIPTION

Reference will now be made in detail to the example embodiments, examples of which are illustrated in the accompanying drawings. Wherever possible, the same reference numbers will be used throughout the drawings to refer to the same or like parts.

Various embodiments for performing automated issue resolution are disclosed. Issue resolution begins when a user transmits a communication to a CSR regarding a symptom of an underlying issue or problem that s/he is experiencing. The symptom of the underlying problem may be, for example, an inability to access the Internet with a certain device. The CSR may then perform operations in an attempt to resolve the user's problem. Some or all of the operations may be recorded. If the CSR successfully resolves the user's problem, the operations may be compared to a model to identify the problem and/or symptoms associated with the problem. After waiting for a predetermined time, the process may determine whether symptoms of the previously identified problem are present and, if so, attempts to resolve the problem.

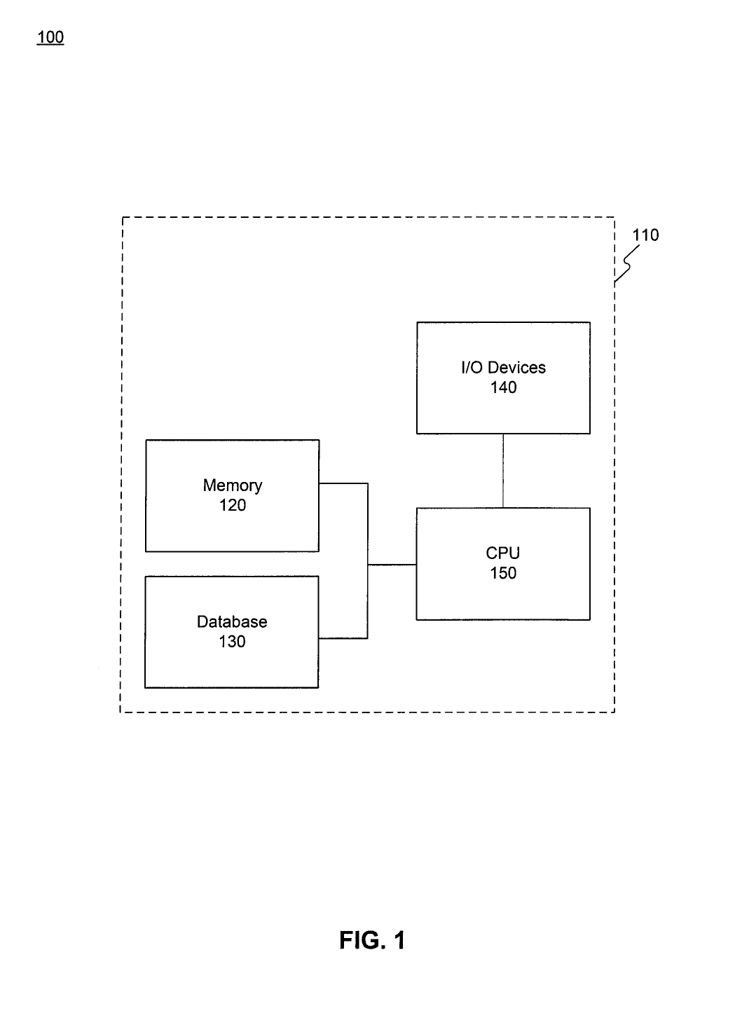

FIG. 1 is a diagram illustrating an example computer system 100 that may be used for implementing the disclosed embodiments. Computer system 100 may include one or more computers 110, which may be servers, personal computers, mobile phones, and/or other types of computing devices. Computer 110 may include, among other things, one or more of the following components: a central processing unit (CPU) 150 configured to execute computer program code to perform various processes and methods, including the embodiments herein described; memory 120, such as RAM, EEPROM, and flash memory, to store data and computer program code; database 130 to store tables, lists, or other data structures; and I/O devices 140 such as a keyboard, mouse, touch-sensitive display and/or monitor. Each of these components is well-known in the art and will not be discussed further.

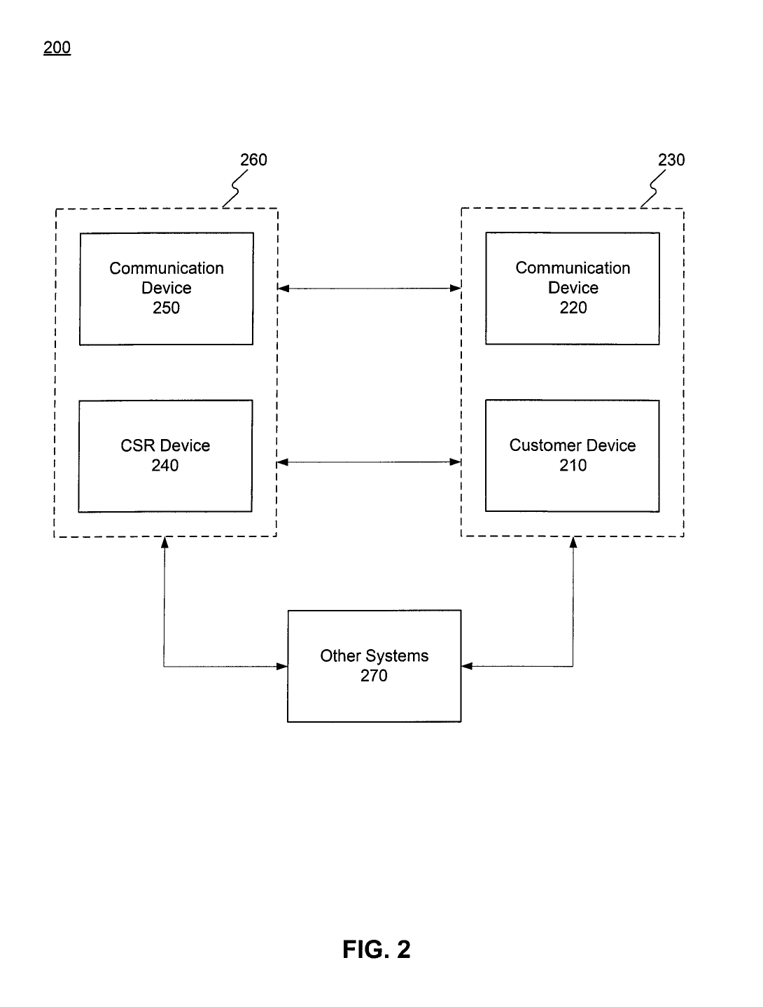

FIG. 2 illustrates an example system 200 that may be used for implementing the disclosed embodiments. System 200 may include a customer system 230 comprising a customer device 210 and, in some embodiments, a communication device 220. Customer device 210 may be an electronic device, such as, for example, computer 110. Customer device 210 is representative of the device for which a customer may have a problem. For example, in embodiments where customer device 210 is a mobile phone, a customer's problem may be an inability to access the Internet. Communication device 220 enables a customer to communicate with a CSR by, for example, voice, video, or text. Communication device 220 may be, for example, a telephone, a videophone, or a computer, such as, for example, computer 110. In some embodiments, communication device 220 may be a component of customer device 210, while in other embodiments, communication device 220 may be a device separate from customer device 210.

In addition, system 220 may include a CSR system 260 comprising a CSR device 240 and, in some embodiments, a communication device 250. CSR device 240 may be an electronic device, such as, for example, computer 110. In some embodiments, CSR device 240 may be configured to access customer device 210. For example, CSR device 240 may be configured to retrieve data stored on customer device 210 and, in some embodiments, control one or more components of customer device 210. Communication device 250 enables a CSR to communicate with a customer by, for example, voice, video, or text. Communication device 250 may be, for example, a telephone, a videophone, or a computer, such as computer 110. Communication device 250 may send data to and receive data from communication device 220. For example, communication device 250 and communication device 220 may communicate over a telephone network or the Internet. In some embodiments, communication device 250 may be a component of CSR device 240, while in other embodiments, communication device 250 may be a device separate from CSR device 240.

In addition, system 200 may include other systems 270. For example, in some embodiments, customer device 210 may communicate with other systems 270, such as remote servers. In such embodiments, data regarding a problem with customer device 210 may be stored in other systems 270. Thus, in such embodiments, CSR device 240 may communicate with other systems 270 to obtain additional information regarding an issue with customer device 210.

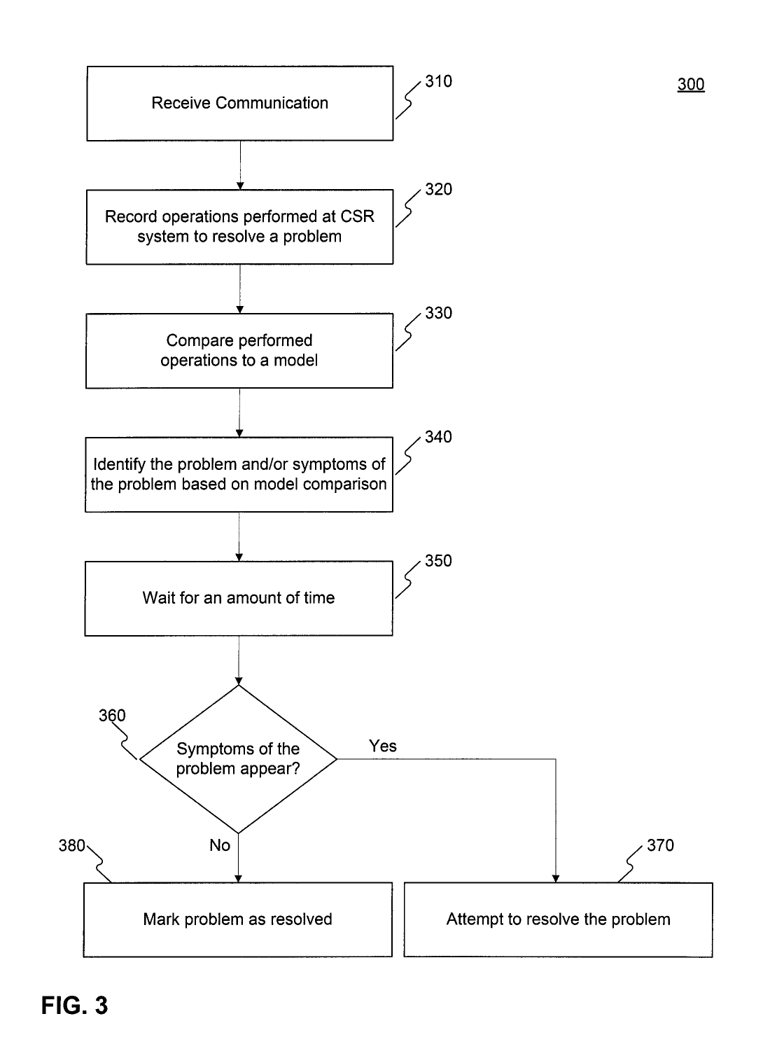

FIG. 3 illustrates an example method 300 for resolving and following up on a problem. Method 300 begins when a communication is received regarding a symptom of an underlying issue or problem that a customer is experiencing (step 310). Such a communication may be, for example, a phone call or an email sent from communication device 220. A customer may initiate such a communication when, for example, experiencing a problem with customer device 210.

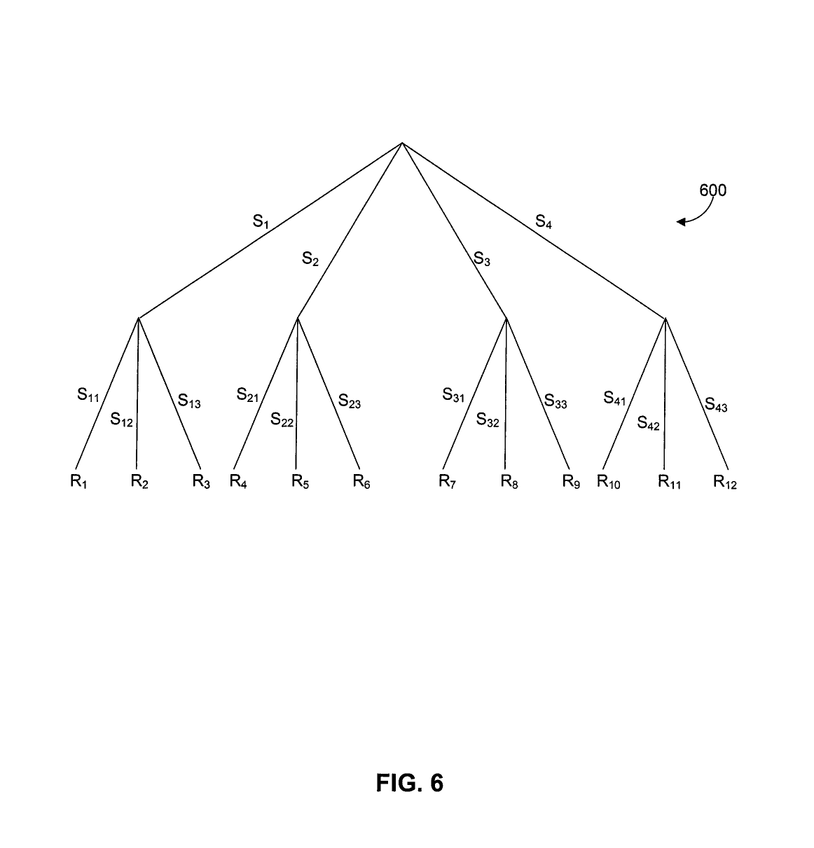

After receiving a communication, a CSR may perform a series of operations at CSR system 260 in an attempt to resolve the problem. Some or all of the operations performed by the CSR to resolve the problem may be recorded (step 320). The recorded steps may then be compared to a model that maps performed operations to underlying problems (step 330). For example, the recorded operations may be compared to model 600, depicted in FIG. 6, by traversing a tree of performed operations to determine an underlying problem. The number of branches and underlying problems in model 600 is only an example, and model 600 may contain any finite number of branches or sub-branches, and any finite number of underlying problems. In addition, while model 600 is depicted with two levels or branches (representative of two recorded operations performed by a CSR), model 600 may contain a plurality of underlying problems that are determined from one or more levels (e.g., some underlying problems may be determined at level one, some underlying problems may be determined at level two, some underlying problems may be determined at level three, etc.). In addition, while model 600 is represented as a tree structure, alternative structures are also possible, such as, for example, an N-dimensional table where N is representative of the maximum number of recorded steps performed by a CSR.

By comparing the recorded operations taken by a CSR to the model 600, the underlying problem may be identified (step 340). For example, if a CSR performed operation S₂ followed by operation S₂₁ to resolve a problem experienced by a customer, and the recorded operations were compared to model 600, a determination would be made that the underlying problem experienced by the customer was R₄. In some embodiments, the CSR may be prompted to confirm that the determined problem is correct, for example, by displaying a message on the CSR device 240. In addition, in some embodiments, the same recorded operations may map to more than one underlying problem. Thus, in some embodiments, a given underlying problem Rₙ may be representative of a set of possible underlying problems. In such embodiments, the CSR may be prompted to select one or more problems from the set of possible problems. In some embodiments, the model provides a set of symptoms corresponding to the possible problems, and symptoms of the identified problem are also identified.

At this point in the process, the customer is no longer experiencing the symptom of the problem for which s/he contacted the CSR. However, problems that a CSR resolves often reoccur after some amount of time. Thus, after waiting for some amount of time (step 350), a determination will be made as to whether symptoms of the previously determined problem appear (step 360). This determination may be made, for example, by comparing data from the customer device 210 or the other systems 270 to a database of symptoms mapped to underlying problems. The symptoms determined in step 360 may be the same as, or different from, the symptom originally experienced by the customer. By performing this determination, a customer does not need to communicate with a CSR to inform a CSR of symptoms that appear.

While in some embodiments a determination is only made as to whether symptoms of the previously determined problem appear for customer device 210, in other embodiments a determination is also made as to whether symptoms of the previously determined problem appear for customer devices other than customer device 210. By also monitoring other customer devices for symptoms of the problem, some other customers experiencing the same problem as the customer associated with customer device 210 may not have to make an initial communication with a CSR. In some embodiments, the set of other customer devices to monitor is determined based on the type of problem. For example, if the previously determined problem is associated with a particular model of a customer device, other customer devices that are the particular model may be monitored. Similarly, for example, if the problem is associated with a particular geographical region, other devices that are within the particular geographical region may be monitored.

If symptoms of the previously determined problem, associated with the customer device 210 and/or the other customer devices, appear, an attempt may be made to resolve the problem (step 370). For example, depending on the nature of the problem, a CSR may be assigned to resolve the problem, the problem may be resolved automatically, or the customer may be contacted with instructions on how to resolve the problem. Alternatively, if the symptoms of the underlying problem do not appear, the problem may be marked as resolved (step 380). In some embodiments, the problem may also be marked as resolved if the attempt to resolve the problem in step 370 is successful.

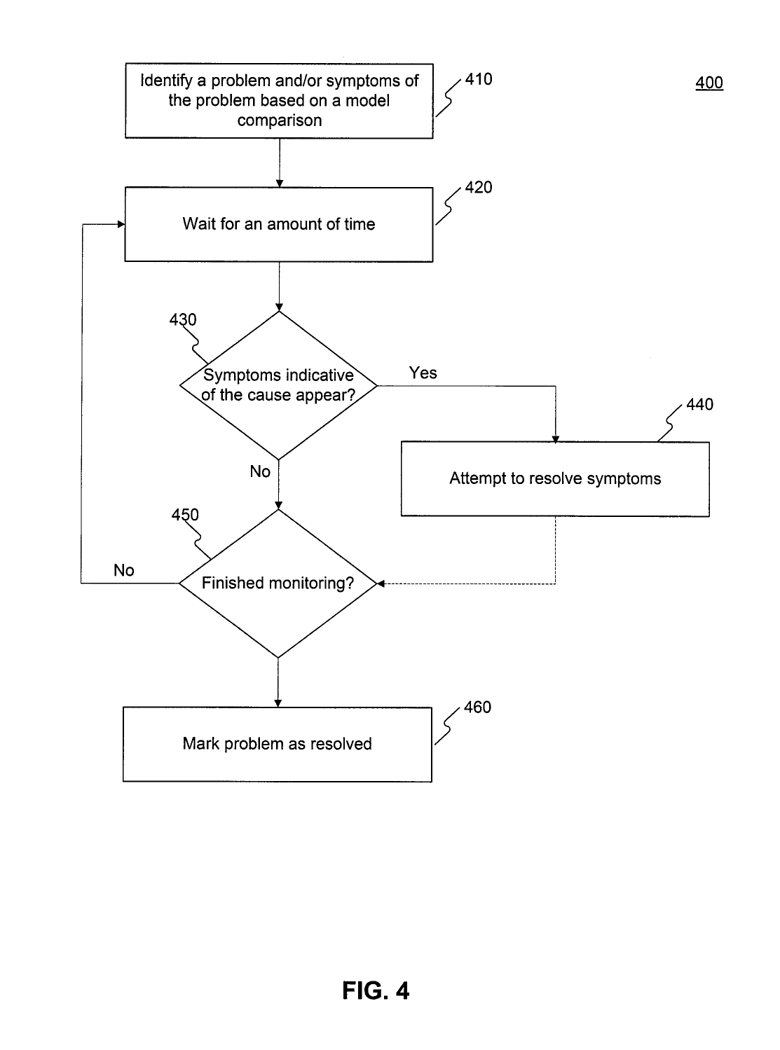

FIG. 4 illustrates an example method 400 for determining that a problem has been resolved. Method 400 begins with a determination of an underlying problem based on a model comparison (step 410). Step 410 may be performed in substantially the same manner as step 340, and prior to step 410, operations equivalent to steps 310-330 may have occurred.

After the underlying problem determination, the method will wait for a first amount of time (step 420). During the initial wait period, the method may wait, for example, for one day or until the end of the current day. After waiting, a determination may be made as to whether symptoms indicative of the underlying problem appear (step 430), in substantially the same manner as described above with respect to step 360. If the symptoms do appear, an attempt to resolve the problem may be made (step 440), in substantially the same manner as described above with respect to step 370.

If the symptoms do not appear or, in some embodiments, the attempt to resolve the problem in step 440 is successful, a determination will be made as to whether monitoring of the underlying problem should continue (step 450). In some embodiments, a predetermined monitoring schedule is used (e.g., symptoms of the underlying problem will be searched for one day, one week, and one month after the customer communicated with the CSR). In other embodiments, a monitoring schedule is determined based on the particular problem that was determined in step 410. For example, some problems may require daily monitoring for a week before monitoring may be completed, while other problems may require weekly monitoring for a month before monitoring may be completed. In some embodiments, the problem may be identified as a recurring problem, for example, by the model comparison. In such embodiments, the monitoring schedule may be set to monitor for the symptoms of the problem indefinitely, until a system administrator turns off monitoring, for the life of the customer device, and/or for the life of a subscription associated with the customer device.

If monitoring is not complete, the method will once again wait (step 420). The time that the method waits may be based on the monitoring schedule, and thus may be the same amount of time or a different amount of time as compared to prior waiting times. The method will continue to repeat steps 420-450 until the method determines that monitoring has been completed. In some embodiments, if the symptoms of the problem do appear at some point during the process, the method resets the monitoring schedule. Once the monitoring has completed, either without the symptoms of the problem reappearing or, if the symptoms do reappear, the symptoms being resolved, the problem is marked as resolved (step 460).

In some embodiments, monitoring is performed with respect to individual customer devices such as, for example, customer device 210, such that a problem is marked as resolved for an individual customer device if symptoms of the problem do not appear for the individual customer device and/or the symptoms are resolved for the individual customer device. In other embodiments, monitoring is performed with respect to a set of customer devices, such as, for example, customer device 210 and other customer devices, such that a problem is marked as resolved for the set of customer devices if symptoms of the problem do not appear for the set of customer devices and/or the symptoms are resolved for the set of customer devices.

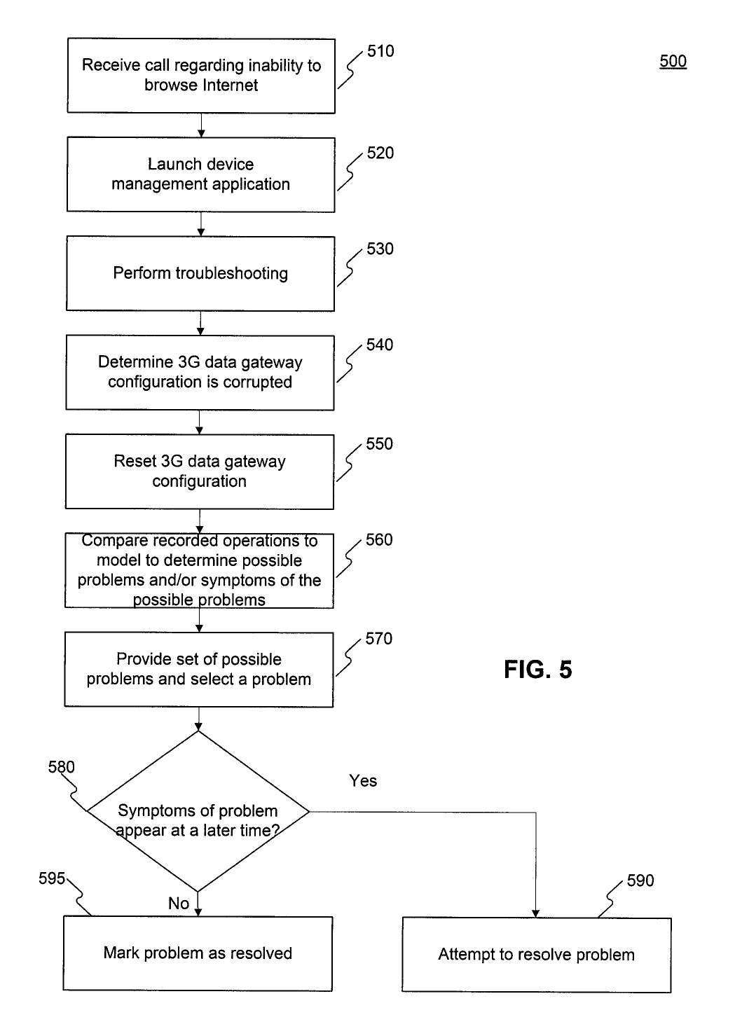

FIG. 5 illustrates an example method 500 for resolving and following up on a problem. Method 500 begins with a CSR receiving a call from a supported user regarding an inability to browse the Internet on a mobile device (step 510). In this example, a supported user is an individual who, alone or via affiliation with an organization, has a relationship with the CSR, or an organization that employs the CSR, to provide technical support in connection with the use of the mobile device. More generally, the term supported user may refer to any entity, including an individual, organization, or machine, supported by a CSR. Similarly, CSR may refer to any entity, including an individual, organization, or machine, that has a relationship with a supported user to provide support services or is configured to provide some sort of support service. A user's inability to browse the Internet on a mobile device is one example of a symptom of an underlying problem.

Upon receiving a call from the user, the CSR launches a device management application (step 520). In some embodiments, a plurality of device-specific device management applications may be available for the CSR to choose from. In other embodiments, a single device management application may be provided that allows the CSR to enter the type of device being dealt with. The method 500 may record data representative of the CSR launching the device management application and, if applicable, entering the type of device being dealt with.

After launching the device management application, the CSR begins to perform troubleshooting (step 530). Some or all of the operations performed by the CSR may be recorded. Eventually, after performing troubleshooting, the CSR may determine, for example, that the 3G gateway configuration of the device is corrupted (step 540). Upon such a determination, the CSR may reset the 3G gateway configuration, and such the resetting operation may be recorded (step 550).

The method 500 will then compare the recorded operations to a model, such as model 600, to determine possible problems that would result in the user's the inability to browse the Internet (step 560). The set of possible problems may then be displayed at the CSR system, such as CSR system 260, and one or more identified problems may be selected from the set (step 570).

The method 500 will then check if symptoms of the determined problem appear at a later time, such as, for example, at the end of the day, end of the week, and end of the month (step 580). If, during any of the checks, the symptoms do reappear, an attempt may be made to resolve the selected problem (step 590). For example, the 3G gateway configuration may be reset again. Alternatively, if none of the checks determine that the symptoms of the problem appear, the problem may be marked as resolved (step 595).

Embodiments and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVDROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client/server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

1. A method for resolving problems, comprising:
storing an identified problem associated with a communication regarding a first symptom of a first problem with a user device, wherein the identified problem corresponds to a particular problem, from a set of possible problems, selected by:
comparing, by a processor, a set of stored operations, performed to resolve the first problem, to a model, wherein the model comprises a mapping between a set of possible operations and the set of possible problems;
monitoring, by a processor, data from a computer system associated with the user device for a second symptom of the stored identified problem;
determining, by a processor, that the second symptom of the identified problem is present in the monitored data; and
performing a second set of operations to resolve the identified problem based on the determination that the second symptom of the identified problem is present in the monitored data.

2. The method of claim 1, wherein the model comprises symptoms associated with the set of possible problems.

3. The method of claim 1, further comprising:
waiting, after the resolution of the first problem, for a first predetermined amount of time before performing the monitoring.

4. (canceled)

5. The method of claim 3, further comprising:
waiting for a second predetermined amount of time after performing the second set of operations; and
determining a third symptom indicative of the identified problem is present after waiting for the second predetermined amount of time.

6. The method of claim 5, wherein the first symptom, the second symptom, and the third symptom are the same symptom.

7. The method of claim 5, wherein the second predetermined amount of time is greater than the first predetermined amount of time.

8. The method of claim 1, wherein the first problem is a malfunctioning device.

9. The method of claim 8, wherein the set of stored operations are performed by a second device different from the malfunctioning device.

10. The method of claim 9, wherein the second device is in communication with the malfunctioning device.

11. A system for resolving problems, comprising:
a processor;
a memory;
program code stored in the memory, which, when executed by the processor, causes the system to perform the steps of:
storing an identified problem associated with communication regarding a first symptom of a first problem with a user device, wherein the identified problem corresponds to a particular problem, from a set of possible problems, selected by:
comparing a set of stored operations, performed to resolve the first problem, to a model, wherein the model comprises a mapping between a set of possible operations and a set of possible problems;
monitoring data from a computer system associated with the user device for a second symptom of the stored identified problem;
determining that the second symptom of the identified problem is present in the monitored data;
performing a second set of operations to resolve the identified problem based on the determination that the second symptom of the identified problem is present in the monitored data.

12. The system of claim 11, wherein the model comprises symptoms associated with the set of possible problems.

13. The system of claim 11, wherein the program code stored in the memory, when executed by the processor, further causes the system to perform the step of:
waiting, after the resolution of the first problem, for a first predetermined amount of time before performing the monitoring.

14. (canceled)

15. The system of claim 13, wherein the program code stored in the memory, when executed by the processor, further causes the system to perform the steps of:
waiting for a second predetermined amount of time after performing the second set of operations; and
determining a third symptom indicative of the identified problem is present after waiting for the second predetermined amount of time.

16. The system of claim 15, wherein the first symptom, the second symptom, and the third symptom are the same symptom.

17. The system of claim 15, wherein the second predetermined amount of time is greater than the first predetermined amount of time.

18. The system of claim 11, wherein the first problem is a malfunctioning device.

19. The system of claim 18, wherein the set of stored operations are performed by a second device different from the malfunctioning device.

20. The system of claim 19, wherein the second device is in communication with the malfunctioning device.

21. The method of claim 1, wherein the first predetermined amount of time comprises a day, a week, or a month.

22. The system of claim 11, wherein the first predetermined amount of time comprises a day, a week, or a month.
